(19) United States
(12) Patent Application Publication
(10) Pub. No.: US 2014/0196978 A1
(43) Pub. Date: Jul. 17, 2014

(54) SILENCER AND METHOD FOR MANUFACTURING THE SAME

(71) Applicant: Henn GmbH & Co KG., Dornbirn (AT)

(72) Inventor: Harald HARTMANN, Dornbirn (AT)

(73) Assignee: Henn GmbH & Co KG., Dornbirn (AT)

(21) Appl. No.: 14/154,363

(22) Filed: Jan. 14, 2014

(30) Foreign Application Priority Data
Jan. 16, 2013 (AT) A 50023/2013

(51) Int. Cl. F02M 35/12

(52) U.S. Cl. CPC F02M 35/1272; F02M 35/1283; F02M 35/1255
USPC 181/229; 29/890.08

(57) ABSTRACT

The invention relates to a silencer (1) and a method for manufacturing a silencer (1), in particular a vehicle silencer, having an inner pipe section (2) and at least one resonator chamber (14, 15) embodied outside the pipe section (2), with the shell (3) of the pipe section (2) having at least one opening (7, 8) that connects the interior of the pipe section (2) with the resonator chamber (14, 15). For simplifying the production process as well as for material and weight savings, the shell segments (4, 5, 6) are prefabricated as individual components and the shell of the inner pipe section (2) is formed by assembling the prefabricated shell segments (4, 5, 6), with the shell segments (4, 5, 6) being arranged to be spread along the circumference of the pipe and extend in axial direction from a first connecting piece (11) to a second connecting piece (12) each, and first ends (9) of the shell segments (4, 5, 6) are connected with the first connecting piece (11) and second ends (10) of the shell segments (4, 5, 6), lying opposite the first ends (9), being connected with the second connecting piece (12).

The invention relates to a silencer, in particular a vehicle silencer, having an inner pipe section and at least one resonator chamber formed outside the pipe section, and the pipe section has at least one opening in its shell, which opening connects the interior of the pipe section with the resonator chamber. The invention also relates to a vehicle having a silencer and a method for manufacturing a silencer.

DE 10026355 A1 discloses a sound damping air duct for an air-intake system of an internal combustion engine having an inner duct with radial holes, and a sound damping cladding at least partly surrounding the outside of the inner duct. An outer duct completely surrounds the inner duct and sound damping cladding. Both the outer duct and the inner duct are each made of two half shells, and a half shell of the inner duct is mounted to a half shell of the outer duct as to pivot, and the other half shell of the inner duct is mounted to the other half shell of the outer duct as to pivot. Inner duct, outer duct and damping cladding are made of plastic material. The disadvantage of this construction is that the manufacture of such an air duct requires an enormous effort. In particular the mutually pivoting mounting of the individual half shells requires several complex worksteps and can only be realized by means of plastic materials in order to keep the costs acceptable. Hence, this solution cannot be chosen for applications requiring the use of metal, such as stainless steel.

WO 07101412 A1 discloses a silencer of modular type of construction and a method of producing it. For this purpose, a number of fluid guide elements forming a labyrinth of channels and resonator chambers is provided. A continuous pipe is not provided, design and construction are very complex and require a number of component parts, the composition of which is very elaborate.

A silencer with an internal pipe and reflection chambers and channels arranged outside has been known from DE 3020492 C2.

DE 736633 A discloses a silencer, wherein the pipe extending inside is not embodied to be continuous. Between two pipe sections, the medium passes two chambers and annular cavities. Radial holes connect the chambers with the annular cavities.

In the last two publications the inner pipe sections are embodied as a pipe which is embodied to be of one piece along its circumference. The disadvantage of such a construction is that the shell of commercially available pipes of a certain diameter has a minimum thickness. In order for a lower shell thickness and thus a reduction of material and weight to be achieved, special constructions would be required which are however very expensive and laborious. Furthermore, bringing radial wholes into a finished pipe is connected to a considerable effort, as the, holes mostly have to be provided along the entire circumference of the pipe, so that the handling and orientation of the pipe during the machining process require a considerable effort already.

The objective of the present invention is to provide a silencer that does not have this disadvantage and that can be manufactured easily and cost-efficiently. This silencer shall allow savings in terms of material and weight. The assembly of the silencer and in particular the manufacturing of the inner pipe section including its openings in its shell have to be effected in an easy and time-saving way. Finally, the silencer should be characterized by an efficient sound damping.

This objective is achieved by a silencer as above-mentioned due to the fact that the shell of the inner pipe section is composed of at least three shell segments (arranged to be adjacent), which are spread along the circumference of the pipe, which shell segments each extend in axial direction from a first connecting piece to a second connecting piece, and first ends of the shell segments are connected with the first connecting piece and second ends opposite the ends of the shell segments are connected with the second connecting piece.

The manufacture and assembly of at least three shell segments to form an inner pipe section have turned out to be particularly easy. The shell segments can be produced individually and independently of one another and are subsequently mounted to form one inner pipe section. Since the segments can be manufactured individually, it is possible to cut them from a thin sheet metal and to subsequently bend them to have the correct shape. Thus, the shell of the inner pipe section can be provided with a thinner wall thickness than it has been possible on the basis of prior art. The saving of material thus achieved results in the silencer being lighter in terms of weight and more cost-efficient. Also the manufacture of radial openings in the shell is made easier due to the fact that they are being produced during the manufacture of the individual shell segments already. The assembly of the individual shell segments to form the inner pipe section does not represent a difficulty.

The shell segments are prefabricated independent of other parts of the silencer, in particular independent of the resonator walls externally surrounding the resonator chamber(s). This pre-fabrication of the shell segments allows optimizing the manufacturing process.

The shell segments each extend continuously from the first connecting piece to the second connecting piece, so that also the inner pipe section is continuous. The inner pipe section serves for guiding or feeding a medium, such as e.g. compressed air of a turbocharger, (thus being a flow duct), whereas the resonator chambers (e.g. Helmholtz resonators) serve for reducing the sound by way of negative interferences.

As seen in cross-section perpendicularly with respect to the axis of the pipe section, each of the shell segments covers a segment of a circle. The required extent of bending an initially planar metal sheet remains comparably low for three or more shell segments and may be realized by simple means, a bending tool, having a high level of precision and reproducibility.

The shell segments are produced individually and achieve their position which is relatively fixed to one another after having been positioned and fixed to the connecting pieces. The shell segments are preferably only connected to one another via the connecting pieces, but this embodiment does not provide for a direct mechanical connection between the shell segments.

The term connecting piece needs to be seen in a broader context and can comprise pipes, pieces of pipes and pieces of hoses. Inside the connecting piece, the medium fed in the inner pipe section is fed onwards; the part “connecting” of the term refers to the fact that the shell segments are connected to the connecting piece. It is preferred that the connecting pieces are each largely or wholly arranged outside the resonator chambers, and a connecting piece forms the inlet and the other connecting piece forms the outlet of the silencer. Between the connecting pieces, the shell segments extend to be continuous, i.e. the inner pipe section is not interrupted. The recesses in the shell segments allow the communication between flow duct (inner pipe section) and the resonator chamber(s).

An embodiment is hence preferred, where the shell of the inner pipe section is composed of exactly three shell segments each covering essentially 120° of the circumference of the pipe, i.e. if there is a circular pipe section, each shell section covers a third of the circular shape. A bending of sheet metals to this extent can be performed without great effort and with a high level of accuracy. It is furthermore preferred that all shell segments have the same shape—which continues to simplify the production process.

As already mentioned, the shell segments are preferably formed from individual, pre-bent pieces of sheet metal, preferably stainless steel sheets, with the result that high-quality silencers are produced.

It is preferred that the first and/or the second ends of the shell segments are welded to the first and/or second connecting piece, with the result that a reliable connection is effected which is easy to produce.

It is preferred that the first and/or the second ends of the shell segments are connected in a force-fitting manner with the first and/or second connecting piece. This can e.g. be effected by means of clamping or crimp connection or clamping pieces.

It is preferred that the first and/or the second ends of the shell segments each have at least one flange-shaped section. This flange-shaped section preferably rests against the end face of the connecting piece thus simplifying the positioning and fastening of the corresponding end to the connecting piece.

It is preferred that the first and/or the second ends of the shell segments each have at least one skirt-shaped section, with the skirt-shaped section resting against an connecting piece. A skirt-shaped section also simplifies the positioning and improves a fix connection with the connecting piece. It possible to design the fastening particularly simple when there is a cooperation with a flange-shaped section.

It is preferred that at least one connecting piece is a pipe, a piece of a pipe, a hose or a piece of a hose, with the result that the silencer can be coupled to the connecting lines in the best possible way.

It is preferred that the axially running edges of adjacent shell segments are positioned to rest against one another in a loose way. It is hence in this case not required that the shell segments are connected with one another along the axially running edges. As the walls of the resonator chamber seal the silencer and thus also the inner pipe section against the outside, a complete tightness of the internal pipe and consequently along the axially running edges is not required, particularly as openings in the direction of the resonator chambers are provided. It is preferred that the axially running edges of all shell segments rest against one another in a loose way, i.e. these edges are not directly fixed to one another. This does not exclude that they are in contact with one another along their entire length.

Another advantage of this embodiment results from the fact that three shell segments or shells can rest against one another in a loose manner, i.e. it is not required for the axially running longitudinal faces or edges of adjacent shell segments to be connected to one another. The loose contact can be used for balancing tolerances of the connecting pieces. If the connection diameters are not completely equal, the gaps between the segments are simply adjusted to balance the tolerances. In a preferred embodiment, a gap running in axial direction results at least between two adjacent shell segments. It is of course also conceivable that axially running gaps are formed between all longitudinal faces.

A separating wall separating two resonator chambers from each other can be embodied to be an annularly shaped wall portion where the inner pipe section passes through. It is preferred that the inner edge of this separating wall rests against the shell segments, with the result that the latter is once more held or supported. A fixed connection between separating wall and shell segments is not absolutely required. It is preferred that this separating wall rests against the shell segments in a loose manner; the latter are held by the connecting pieces anyway. The outer edge of the separating wall rests against the resonator chamber sealing against the outside. Thus, a mechanically firm construction is provided.

It is preferred that the cross-section of the shell segments is arc-shaped, preferably circular-arc-shaped, perpendicular to the axial direction, with the result that a space-saving and, as regards sound-absorption, optimized geometry results. It is thus also possible that the inner pipe section is produced from identically formed shell segments.

It is preferred that each shell segment has at least one, preferably at least two, recesses forming the openings in the shell of the inner pipe section. The recesses can be completely surrounded openings in the individual shell segments or can be one recess which is open towards an axially running edge of the shell segment which recess becomes completely enclosed openings after the individual shell segments have been assembled.

It is preferred that the shell segments forming the inner pipe section are of the same size and shape, with preferably shape, arrangement and size of the recesses being the same for all shell segments. Thus, a uniform shape for all shell segments results so that the manufacturing process is much simplified.

It is preferred that the at least one resonator chamber surrounds the inner pipe section along its entire circumference, with the result that a space-saving and, as regards sound-absorption, optimized geometry is created.

It is preferred that the silencer has at least two resonator chambers that are arranged one behind the other in axial direction, and the shell of the inner pipe section has first openings that open into the first resonator chamber and the second openings that open into the second resonator chamber. This solution is particularly efficient in terms of sound-absorption.

It is preferred that the inner pipe section is completely surrounded by resonator chamber walls. In this case, tightness against the outside is achieved by the resonator chamber walls, so that a perfect tightness of the inner pipe section is not required.

It is preferred that the silencer is a turbocharger silencer that is arranged on the discharge side of a turbocharger. The turbocharger silencer serves for reducing the sound emissions on the discharge side of the turbocharger. The silencer may be plugged onto a short pressure hose directly at the outlet of the turbocharger and fixed, e.g. by means of a spring band clamp.

The above-mentioned objective is also achieved by a vehicle, in particular a road vehicle, having a silencer, in particular a turbocharger silencer that is embodied in accordance with the above-described embodiments.

The above-mentioned objective is, however, also achieved by a method for manufacturing a silencer, in particular a vehicle silencer, having an inner pipe section and at least one resonator chamber designed outside the pipe section, with the pipe section having at least one opening in its shell, which opening connects the interior of the pipe section with the resonator chamber. This being the case, the individual shell segments are completely prefabricated and the prefabricated shell segments are assembled to be the inner pipe section when the silencer is being assembled.

This is achieved by the shell segments that are prefabricated as individual components and by the prefabricated shell segments that are assembled to form the shell of the inner pipe section, with the shell segments being arranged to be spread along the circumference of the pipe, and extending in axial direction from the first connecting piece to a second connecting piece each, and the first ends of the shell segments being connected with the first connecting piece, and the second ends of the shell segments, opposite the first ends, being connected with the second connecting piece.

The shell segments which are prefabricated as separate individual components (i.e. they are not at all connected to one another or to other parts of the silencer being created) are brought into a fixed position with respect to one another when they are being assembled to form the inner pipe section.

Thus, the manufacturing process is split up into two steps; in a first step, the shell segments are prefabricated individually, in a second step, the prefabricated shell segments have only to be assembled. This allows a production of shell segments with high precision, there will be no difficulties during assembly, as tolerances of the shell segments can be kept low. The ends of the shell segments are fixed to the respective connecting pieces. It is preferred that there is no direct connection between the adjacent shell segments via their axially running edges. This reduces the assembly to fixing the connecting pieces opposite each other.

In a particularly preferred embodiment, the shell of the inner pipe section is composed of at least three shell segments, preferably of exactly three shell segments each covering essentially 120° of the circumference of the pipe. If there are three or more shell segments, the bending angle or the segment angle is not that great in order to allow to be produced in a reproducible way and having low tolerances. If there are exactly three shell segments each covering a circumferential region of approximately 120°, an optimized solution is achieved in terms of manufacture (bending or segment angle are well controllable; manufacture of equally formed shell segments as individual components), as well as in terms of the assembly (three shell segments are only a few parts to be assembled).

It is preferred that the each shell segment is produced by a bending a piece of sheet metal, preferably a piece of a stainless steel sheet, and the shell segments are brought into a shape having an arc-shaped, preferably circular-arc-shaped, cross-section by way of the bending process. Due to this method it is possible to use very thin metal sheets, e.g. having a thickness of less than 1 mm, with the result that savings in terms of material, weight and costs can be achieved. Bending the metal sheet to have a shape in order to form, together with one or several other further shell segments, a shell does not represent a problem. If there are three shell segments—preferably of the same size and shape—the bending angle or the segment angle is relatively low, so that complying with the tolerances does not cause problems during the bending process. An embodiment having exactly three shell segments each covering a bow of 120° is here preferred as well.

It is preferred that prior to the bending process the pieces of sheet metal are cut out of an essentially planar metal sheet to have the size of the shell segments.

The shell segments are each produced by cutting a piece of sheet metal out of an essentially planar metal sheet and subsequent bending the piece of sheet metal to have a shape that has an essentially arc-shaped, preferably circular-arc-shaped cross-section. Cutting out of a planar metal sheet, e.g. by means of a laser, can be effected with high accuracy.

In a preferred embodiment, the segments are directly produced from a strip of sheet metal. The strip of sheet metal or the band is then prepared to have the corresponding width, so that no lateral machining is required anymore, and no waste is produced neither. In this embodiment, the width of the strip of sheet metal corresponds to the width of the shell segment to be produced. This allows a production “on belt”.

It is preferred that prior to the shell segments being assembled to be the inner pipe section, at least one flange-shaped section is formed to the first ends and/or the second ends of the shell segments each, with the result that the subsequent positioning and fixing to the connecting piece is simplified.

It is preferred that prior to the shell segments being assembled to be the inner pipe section, at least one skirt-shaped section is formed to the first ends and/or the second ends of the shell segments each, with the result that the subsequent positioning and fixing to the connecting piece is simplified.

It is preferred that prior to the bending of the piece of sheet metal, recesses are brought into the piece of sheet metal, which recesses form the openings in the shell of the inner pipe section when the shell segments are in an assembled state, and it is preferred that the recesses are produced by laser machining. The recesses can be produced very accurately when the piece of sheet metal is in an unbent state.

It is preferred that the first and/or the second ends of the shell segments are welded to the first and/or the second connecting piece.

It is preferred that the first and/or the second ends of the shell segments are connected in a force-fitting manner with the first and/or the second connecting piece.

For a better understanding of the invention the latter is explained in more detail with reference to the following figures.

The heavily simplified schematics show:

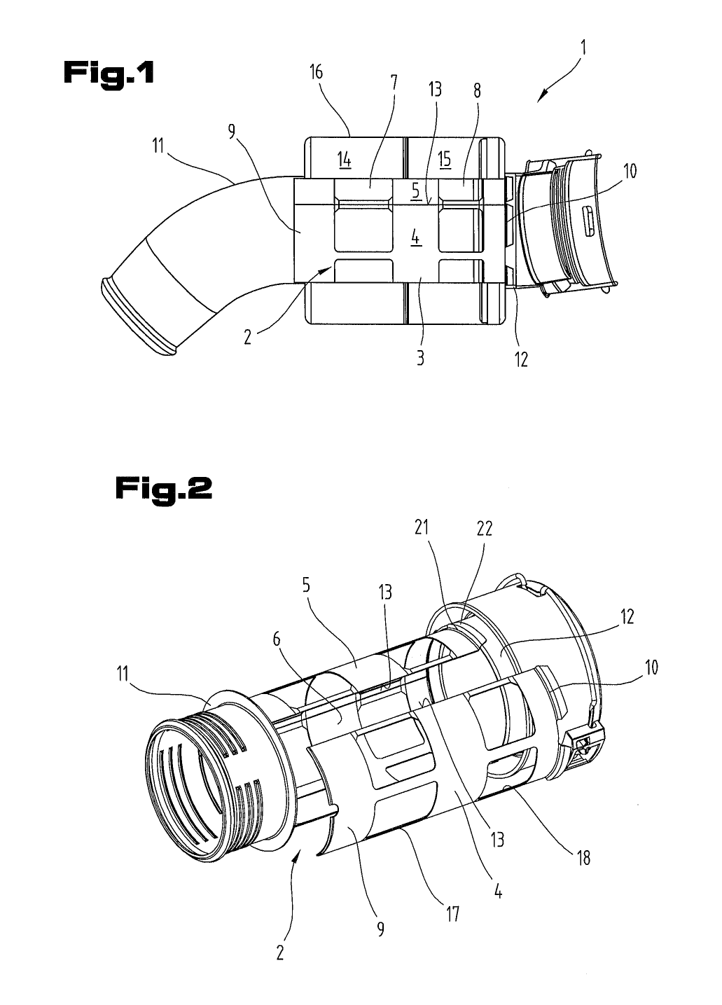

FIG. 1 a silencer according to the invention;

FIG. 2 the inner pipe section of an embodiment of the silencer according to the invention;

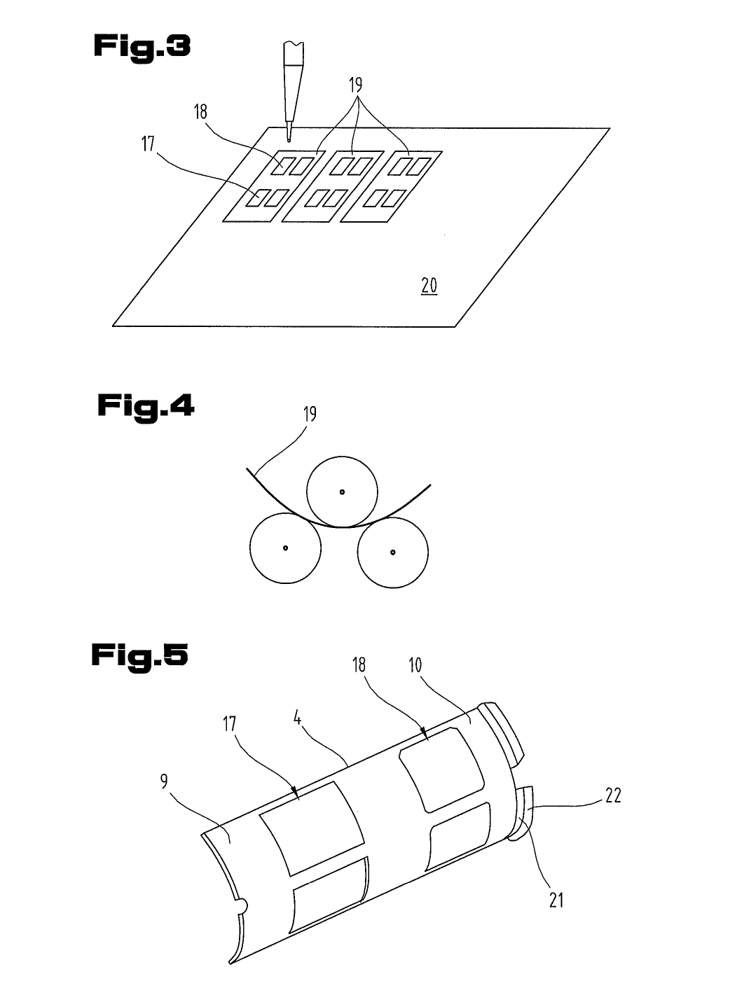

FIG. 3 a manufacturing step of a shell segment;

FIG. 4 a further manufacturing step of a shell segment;

FIG. 5 a prefabricated shell segment;

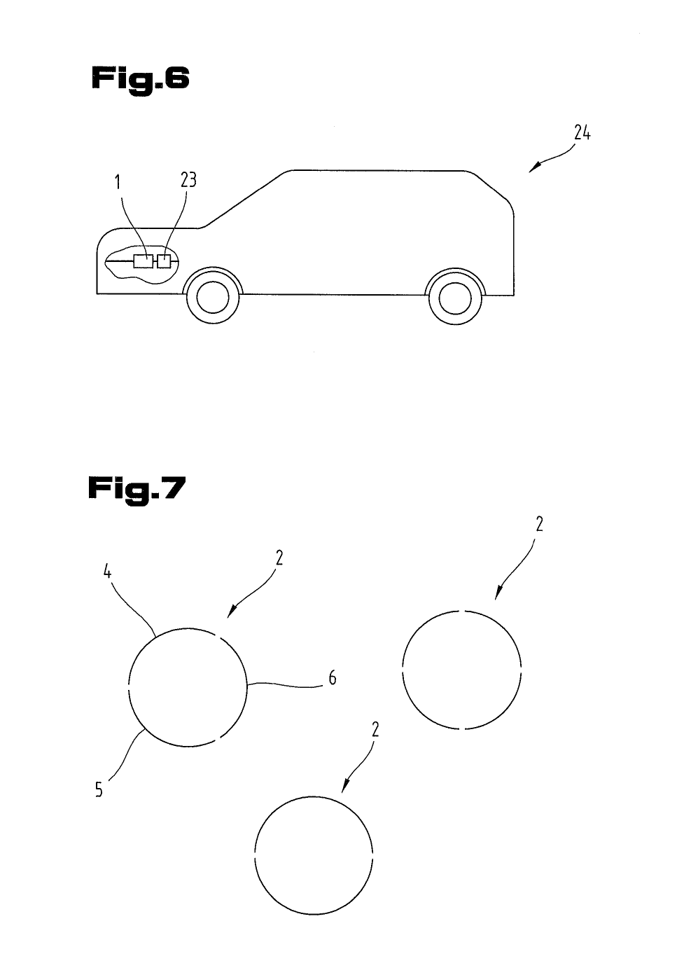

FIG. 6 a vehicle having a silencer, and

FIG. 7 variants of a silencer that can be produced by way of the method according to the invention.

It must first be stated that in the various embodiments described, identical parts have been marked with the same reference identifiers and the same parts descriptions. It is therefore possible to transfer the disclosures contained in the overall description to the identical parts with the same reference identifiers or the same parts descriptions. The selected positioning terms are used in the description, such as top, bottom, side etc., which refer directly to the described and the depicted figures and which can be correspondingly transferred to the new position in the event of a change in position. Furthermore, individual characteristics or combinations of characteristics from the various embodiments shown and described can present independent or inventive solutions, or solutions according to the present invention.

The embodiments illustrated as examples represent possible variants of the silencer, and it should be pointed out at this stage that the invention is not specifically limited to the variants specifically illustrated, and instead the individual variants may be used in different combinations with one another and these possible variations lie within the reach of the person skilled in this technical field given the disclosed technical teaching. Accordingly, all conceivable variants which can be obtained by combining individual details of the variants described and illustrated are possible and fall within the scope of the invention.

FIG. 1 shows a silencer 1 according to the invention having an inner pipe section 2 that is surrounded by two resonator chambers 14, 15 arranged one behind the other in axial direction. First openings 7 and second openings 8 are formed into the shell 3 of the inner pipe section 2. The first openings 7 are spaced apart from the second openings 8 in axial direction. The first openings 7 open into the first resonator chamber 14 and the second openings 8 open into the second resonator chamber 15. The resonator chambers 14, 15 surround the pipe section 2 along its entire circumference in the form of an annular volume. The two resonator chambers 14, 15 are separated from each other by an annularly extending separating wall. The resonator chambers walls 16 seal the silencer 1 against outside. By adjusting the resonator volumes and the openings 7, 8 according to the frequencies to be damped, a negative interference may be obtained, at which the sound can at least partly be extinguished by corresponding phase displacements.

The inner edge of the annular separating wall between the resonator chambers 14, 15 where the inner pipe section 2 passes through rests against the shell segments 4, 5, 6, with the result that the latters are additionally held or supported. The position of the separating wall within the housing part determines the volume of the resonator chambers. As an individual component, e.g. having flanged external and/or internal wall, the separating wall can be inserted at a desired place into the housing part formed from the resonator chamber wall 16 and connected to the housing part, e.g. welded. It is naturally conceivable that the separating wall is also fixed, e.g. welded to the shell segments 4, 5, 6.

The two ends of the inner pipe section 2 continue in the connecting pieces 11, 12. As already indicated in FIG. 1, the shell 3 is composed of individual shell segments 4, 5, 6. The axially running edges 13 of adjacent shell segments rest against one another in a loose way.

FIG. 2 shows the inner pipe section 2 in detail. Firstly, it should be noted that the connecting pieces 11, 12 have another form than those in FIG. 1. In general, any possible form is conceivable; the connecting pieces 11, 12 can be designed as pieces of pipes, pressure hose or piece of hose.

According to the invention, the pipe section 2 is composed of individual shell segments 4, 5, 6, which shell segments have recesses 17, 18. In an assembled state they form the openings 7, 8 of the shell 3. In the preferred embodiment shown, each individual shell segment extends across a third of the circumference of the pipe. In terms of form, size and recess, they are each designed to be equal.

At one of their ends, the second ends 10, the shell segments have two flange-shaped sections 21 each having axially protruding skirt-shaped sections 22. The sections 21, 22 serve for positioning and fixing the shell segments to the end face of the second connecting piece 12. The fixing can e.g. be performed by welding or force-fitting connections. At the first ends 9 of the shell segments, no particular design is provided. The first ends 9 are plugged into e.g. an annular extending slot or recess of the first connecting piece 11 and fixed there by e.g. welding.

The advantage of the construction of the inner pipe section 2 resides in the fact that the shell segments are prefabricated individually, i.e. independent of other parts of the silencer to be created, and subsequently assembled in a way of a modular construction system to form the pipe section 2. The individual shell segments are thus at first present as prefabricated individual components, i.e. in a loose way, i.e. not connected to one another at all. When the inner pipe section is assembled, the shell segments are joined and brought into a fixed position with respect to one another.

FIGS. 3 and 5 give an outline of the individual steps for a possible method for manufacturing a silencer. According to FIG. 3, pieces of sheet metal 19 having the size of the future shell segments are cut out of a planar metal sheet 20 in a first step. It is preferred that also the recesses 17, 18 are cut out when the pieces of sheet metal 19 are still in their planar state. These steps are preferably performed by way of laser cutting.

FIG. 4 shows a piece of sheet metal 19 being subjected to a bending process. This being the case, an arc-shaped, preferably circular-arc-shaped contour of the piece of sheet metal 19 is produced by means of a bending tool, e.g. an arrangement of cylinders or rollers positioned to be relative to one another.

FIG. 5 shows an already prefabricated shell segment 4, where also the flange-shaped sections 21 and the therefrom axially protruding skirt-shaped sections 22 are formed on. These are integrally formed with the shell segment 4. It is of course conceivable that also only one (individual) flange-shaped section 21, i.e. without a skirt-shaped section 22, is created. It is possible for the sections 21, 22 to be formed prior to and/or during the bending process.

Once the assembly of the inner pipe section pipe section 2 is performed, the attachment of the resonator chambers 14, 15 or the resonator chamber walls 16 including their fixation at the silencer is performed.

FIG. 7 shows possible variants of a pipe section 2 of a silencer that can be produced by way of a method according to the invention. In the first variant, a pipe section 2 comprising three shell segments 4, 5, 6 is shown; on its right hand side, one pipe section 2 made of four shell segments, and below, one pipe section 2 comprising only two shell segments is shown. It is of course also possible that the shell segments comprise five or more segments. This, however, increases the effort during assembly, too.

It is in this connection expressively stated that the invention also includes a silencer according to the invention which is composed of at least two shell segments.

FIG. 9 finally shows a vehicle 24 having a turbocharger 23 and a silencer 1 which has been produced according to the invention and which is connected to the discharge side of the turbocharger 23.

The fundamental function of the independent inventive solutions can be taken from the description.

Mainly the individual embodiments shown in the individual Figures can form the subject matter of independent solutions according to the invention. The objectives and solutions ac-cording to the invention relating hereto can be taken from detailed descriptions of these Figures.

### LIST OF REFERENCE NUMERALS

1 Silencer

2 Inner pipe section

3 Shell

4 Shell segment

5 Shell segment

6 Shell segment

7 First opening

8 Second opening

9 First end

10 Second end

11 First connecting piece

12 Second connecting piece

13 Axially running edge

14 First resonator chamber

15 Second resonator chamber

16 Resonator chamber wall

17 Recess

18 Recess

19 Piece of sheet metal

20 Planar metal sheet

21 Flange-shaped section

22 Skirt-shaped section

23 Turbocharger

24 Vehicle

1. Silencer (1), in particular a vehicle silencer, having an inner pipe section (2) and at least one resonator chamber (14, 15) embodied outside the pipe section (2), with the shell (3) of the pipe section (2) having at least one opening (7, 8) that connects the interior of the pipe section (2) with the resonator chamber (14, 15), wherein the shell (3) of the inner pipe section is composed of at least three shell segments (4, 5, 6) arranged to be adjacent along the circumference of the pipe, which shell segments extend from a first connecting piece (11) to a second connecting piece (12) each, with first ends (9) of the shell segments (4, 5, 6) being connected with the first connecting piece (11) and second ends (10) of the shell segments (4, 5, 6), arranged opposite the first ends (9), being connected with the second connecting piece (12).

2. Silencer according to claim 1, wherein the shell (3) of the inner pipe section (2) is composed of three shell segments (4, 5, 6), each extending along the circumference of the pipe about essentially 120°.

3. Silencer according to claim 1, wherein the shell segments (4, 5, 6) are made of individual, pre-bent pieces of sheet metal (19), preferably of stainless steel sheets.

4. Silencer according to claim 1, wherein the first ends (9) and/or the second ends (10) of the shell segments (4, 5, 6) are welded or connected in a force-fitting manner to the first and/or the second connecting piece (11, 12).

5. Silencer according to claim 1, wherein the first ends (9) and/or the second ends (10) of the shell segments (4, 5, 6) each have at least one flange-shaped section (21).

6. Silencer according to claim 1, wherein the first ends (9) and/or the second ends (10) of the shell segments (4, 5, 6) each have at least one skirt-shaped section (22), with the skirt-shaped section (22) resting against a connecting piece (12).

7. Silencer according to one of claim 1, wherein the axially running edges (13) of the adjacent shell segments (4, 5, 6) rest against one another in a loose manner, and wherein preferably a slot which extends in axial direction is embodied at least between two adjacent shell segments (4, 5, 6).

8. Silencer according to claim 1, wherein the cross-section of the shell segments (4, 5, 6) is, perpendicular with respect to the axial direction, embodied to be arc-shaped, preferably circular-arc-shaped.

9. Silencer according to claim 1, wherein each shell segment (4, 5, 6) has one, preferably two, recesses (17, 18) forming the openings (7, 8) in the shell of the inner pipe section (2).

10. Silencer according to claim 1, wherein the shell segments (4, 5, 6) forming the inner pipe section (2) are of the same size and shape, with preferably shape, arrangement and size of the recesses (17, 18) being the same in all shell segments (4, 5, 6).

11. Silencer according to claim 1, wherein the at least one resonator chamber (14, 15) surrounds the inner pipe section (2) along its entire circumference.

12. Silencer according to claim 1, wherein the silencer (1) has at least two resonator chambers (14, 15) which are separated from one another and arranged to be one behind the other in axial direction, with the shell (3) of the inner pipe section (2) having first openings (7) which open into the first resonator chamber (14), and second openings (8) which open into the second resonator chamber (15).

13. Vehicle, in particular road vehicle, having a silencer (1), in particular a turbocharger silencer, which is arranged on the discharge side of a turbocharger (23), wherein the silencer (1) is a silencer according to claim 1.

14. Method for manufacturing a silencer (1), in particular a vehicle silencer, having an inner pipe section (2) and at least one resonator chamber (14, 15) embodied outside the pipe section (2), with the shell (3) of the pipe section (2) having at least one opening (7, 8) that connects the interior of the pipe section (2) with the resonator chamber (14, 15), wherein the shell segments (4, 5, 6) are prefabricated as individual components, and wherein the shell of the inner pipe section (2) is formed by assembling the prefabricated shell segments (4, 5, 6), with the shell segments (4, 5, 6) being arranged to be spread along the circumference of the pipe and extending in axial direction from a first connecting piece (11) to a second connecting piece (12) each, and wherein first ends (9) of the shell segments (4, 5, 6) are connected with the first connecting piece (11), and second ends (10) of the shell segments (4, 5, 6), lying opposite the first ends (9), are connected with the second connecting piece (12).

15. Method according to claim 14, wherein the shell (3) of the inner pipe section (2) is composed of at least three shell segments (4, 5, 6), preferably of three shell segments (4, 5, 6), each essentially covering 120° of the circumference of the pipe.

16. Method according to claim 14, wherein each of the shell segments (4, 5, 6) is manufactured by way of bending a piece of sheet metal (19), preferably a stainless steel sheet, with the shell segment (4, 5, 6) being brought into a shape having an arc-shaped, preferably circular-arc-shaped, cross-section by way of the bending process.

17. Method according to claim 16, wherein prior to the bending process, the pieces of sheet metal (19) are cut out of an essentially planar metal sheet (20) to have the size of the shell segments (4, 5, 6), wherein preferably the metal sheet (20) is provided having the shape of a strip of sheet metal, the width of which already corresponds to the width of the shell segment (4, 5, 6) to be prefabricated.

18. Method according to claim 16, wherein prior to the bending process, recesses (17, 18) are brought into the piece of sheet metal (19), which recesses form openings (7, 8) in the shell (3) of the inner pipe section (2) when the shell segments (4, 5, 6) are in their assembled state, wherein preferably the formation of the recesses (17, 18) is performed by laser machining.

19. Method according to claim 14, wherein at least one flange-shaped section (21) and/or at least one skirt-shaped section (22) is formed on each of the first ends (9) and/or second ends (10) of the shell segments (4, 5, 6).

20. Method according to claim 14, wherein the first ends (9) and/or the second ends (10) of the shell segments (4, 5, 6) are welded or connected in a force-fitting manner to the first and/or the second connecting piece (11, 12).
